(19) United States
(12) Patent Application Publication
(10) Pub. No.: US 2009/0034580 A1
(43) Pub. Date: Feb. 5, 2009

(54) Method for Measuring Heat Release of Polymeric Compounds

(76) Inventors: Thomas S. Lin, Whippany, NJ (US); Jeffrey Morris Cogen, Flemington, NJ (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/182,281

(22) Filed: Jul. 30, 2008

Related U.S. Application Data
(60) Provisional application No. 60/952,696, filed on Jul. 30, 2007.

(51) Int. Cl. G01N 25/22

(52) U.S. Cl. 374/36; 374/E19.001

(57) ABSTRACT

The invention provides a method for measuring the heat release rate of a flame retardardant compound in a microscale combustion calorimeter.

### CROSS REFERENCE TO RELATED APPLICATIONS

This application claims priority to U.S. Provisional Application Ser. No. 60/952,696, filed Jul. 30, 2007, which is incorporated by reference herein in its entirety.

### BACKGROUND OF THE INVENTION

Heat release rate of a compound or composition is a critical factor in assessing the fire hazard potential of a material. In a fire, the temperature at which a combustible material ignites (the ignition temperature), the rate of mass loss as the material subsequently burns (the burning rate), the rate at which the material releases heat in flaming combustion (heat release rate), and the maximum amount of heat that can be released by burning (heat of combustion) are the primary indicators of the material's hazard to life and property. Typically, fire hazard indicators such as ignition temperature, burning rate, heat release rate, and heat of complete combustion are measured using procedures published by the American Society for Testing and Materials (ASTM) in at least three separate devices requiring at least 1 kilogram of material to complete all of the tests. A number of different methods and fire calorimeter apparatuses have been developed, and are used currently, which provide for the measurement and quantification of the heat release rate of burning samples. Some of the well developed bench scale methods require samples on the order of hundreds of grams, which consequently result in samples having large mass and dimensions. For example, the resulting thickness of these samples can skew results such that the measurements incorporate inaccuracy due to heat transfer within the sample. Further, results from samples of such size can depend not only on the sample mass and thickness but also on the spatial orientation of the sample, boundary conditions, ignition source, and other parameters of the test setup that are totally independent of the inherent properties of the sample material. Consequently, the flammability parameters determined using these devices incorporate operationally-defined extrinsic quantities and do not rely solely on the intrinsic properties of the sample, which is important in the development of fire resistant polymers.

A recently developed method and apparatus, termed a “pyrolysis combustion flow calorimeter” (PCFC), “microscale combustion calorimeter” (MCC), or “flammability tester,” (depending on the reference) is described in U.S. Pat. Nos. 5,981,290, 6,464,391 and published U.S. patent application 2006/0133445 (each of which is incorporated by reference herein) provides an instrument and method that measures specific heat release rate, heat release capacity, and total heat released in a single, rapid, and quantitative test using a small amount (milligrams) of substance. While a number of such advancements have been made in the art of combustion science and calorimetry, the inventors have observed that PCFC does not provide a good correlation between heat release capacity and peak heat release rate (PHRR) as measured by cone calorimetry for some polymeric systems comprising flame retardant agents. Thus, there remains a need in the art for additional apparatuses and methods for measuring flammability parameters of a compound or compositions, such as heat release rate, on a small scale that provide a good correlation with the heat release rate measured by established techniques, such as cone calorimetry, for samples comprising flame retardant agents.

### SUMMARY OF THE INVENTION

In one aspect, the invention encompasses a method of measuring the flammability parameters of a sample comprising:
(a) thermally decomposing the sample at an essentially constant temperature to generate fuel gases;
(b) transporting the fuel gases to a furnace via a carrier gas stream;
(c) combusting a mixture comprising the carrier gas and the fuel gases in the furnace; and
(d) analyzing the effluent generated in (c) to measure the flammability parameters of said sample;
   wherein if the fuel gases and the carrier gas together do not comprise a sufficient amount of oxygen gas adequate to allow for combustion before the combusting in (c), a sufficient amount of oxygen gas is added to the fuel gases and the carrier gas mixture prior to or during combusting in (c).

In another aspect the invention relates to a method of measuring the heat release rate of a sample comprising:
(a) thermally decomposing the sample at an essentially constant temperature in a pyrolysis chamber to generate fuel gases;
(b) transporting the fuel gases generated in (a) via a carrier gas stream to a furnace;
(c) combusting the fuel gases in the furnace generating a gaseous effluent, wherein the fuel gases comprise an amount of oxygen adequate to allow for combustion;
(d) measuring the amount of oxygen remaining in the gaseous effluent; and
(e) comparing the measured amount of oxygen remaining in the gaseous effluent with the amount of oxygen in the fuel gases prior to combustion in (c) to calculate the heat release rate of the sample.

Other specific embodiments of the invention will become evident from the following detailed description of the invention and the appended claims.

### BRIEF DESCRIPTION OF DRAWINGS

FIG. 1. Graphical representation of data from peak heat release rate from cone calorimetry and heat release capacity from PCFC for compositions comprising a flame retardant component, using a constant increase in pyrolysis zone temperature. MGH stands for magnesium hydroxide.

FIG. 2. Graphical representation of data from peak heat release rate from cone calorimetry and peak specific heat release rate from PCFC for compositions comprising a flame retardant component, the method including an isothermal pyrolysis zone temperature. MGH stands for magnesium hydroxide.

FIG. 3. Graphical representation of data from peak heat release rate from cone calorimetry and heat release capacity from PCFC for compositions comprising a flame retardant component, using a constant increase in pyrolysis zone temperature. MGH stands for magnesium hydroxide.

FIG. 4. Graphical representation of data from peak heat release rate from cone calorimetry and peak specific heat release rate from PCFC for compositions comprising a flame retardant component, the method including an isothermal pyrolysis zone temperature. MGH stands for magnesium hydroxide.

### DETAILED DESCRIPTION OF THE INVENTION

### Definitions

The term “fuel gases” refers to all of the mass lost from the sample during pyrolysis in the pyrolysis zone or pyrolysis chamber (the terms pyrolysis zone and pyrolysis chamber are interchangeable as used herein, unless otherwise noted), even though not all of the mass lost during pyrolysis is fuel in the conventional sense, (i.e. some of the mass loss may be water and other non-combustible products).

As used herein, “burning rate” is the rate at which a sample generates fuel gases (loses mass) in a fire. Burning rate is measured often simultaneously with heat release rate in flaming combustion using fire calorimeters with sample weighing capability such as ASTM E 1354, Standard Test Method for Measuring Heat and Visible Smoke Release Rates for Materials and Products Using an Oxygen Consumption Calorimeter, and ASTM E 2058, Standard Test Method for Measurement of Synthetic Polymer Material Flammability Using a Fire Propagation Apparatus. Burning rate can be measured without measuring heat release rate in a separate device described in ASTM E 2102-04a, Standard Test Method for Measurement of Mass Loss and Ignitability for Screening Purposes Using a Conical Radiant Heater.

The term “heat release rate” is taken to mean the rate at which heat is liberated by flaming combustion in a fire. The heat release rate is commonly expressed in units of kW/m². Heat release rate commonly is measured in fire calorimeters such as described in ASTM E 1354, Standard Test Method for Measuring Heat and Visible Smoke Release Rates for Materials and Products Using an Oxygen Consumption Calorimeter, and ASTM E 2058, Standard Test Method for Measurement of Synthetic Polymer Material Flammability Using a Fire Propagation Apparatus. Fire calorimeters typically measure the heat release rate with simultaneous measurement of the fuel gas generation (mass loss) rate of a substance.

“Heat of combustion” means the quantity of heat liberated by oxidation of fuel gases. Heat of combustion is measured in both flaming mode and non-flaming mode. The heat of combustion (Joules) is obtained by multiplying the heat release rate (Joules/second) by the sampling interval (seconds) at each point of time during the heat release rate test and summing the results.

As used herein, the term “oxygen” when used with reference to any portion of the methods of the invention means dioxygen gas (O₂). Thus, for example, when oxygen is said to be present in an amount adequate to allow for combustion or when residual oxygen in effluent is measured, the term oxygen refers to O₂ gas, if not specified otherwise.

In PCFC or microscale combustion calorimetry the specific heat release rate in units of W/g is calculated based on oxygen consumption rate during the test. The “peak specific heat release rate” (PSHRR) is defined as maximum specific heat release rate calculated from the maximum consumption rate of oxygen during the test. The heat release capacity in units of J/g-K or J/g-° C. is calculated by dividing peak specific heat release rate with the sample heating rate in units of K/sec or ° C./sec. Heat release capacity is considered as maximum potential of the material to release combustion heat in a fire or flame and approximates an equilibrium property of the material.

“Essentially constant” as used herein when referring to temperature means that the temperature is maintained within ±10% of a particularly stated temperature. For example, when practicing the method of the invention, the temperature of the calorimeter in the pyrolysis zone can be held essentially constant at a particular temperature, for example 500° C. (i.e., from about 450-550° C.).

There are certain relationships between the various flammability parameters discussed above. For example, the heat release rate (HRR) is the product of the mass loss rate (MLR), also termed burning rate, and the heat of combustion (HOC): HRR=MLR×HOC. In practice (i.e., in fire calorimeters) mass loss rate and heat release rate are often measured continuously during the test by gravimetry and oxygen consumption, respectively. These quantities can be used to calculate the instantaneous heat of combustion during the test HOC=HRR/MLR. If the heat of combustion does not change significantly during the test, the mass loss rate at any time is MLR=HRR/HOC. Similarly, peak specific heat release rate (PSHRR) can be converted to heat release capacity (HRC) using the heating rate (HtRt) under non-isothermal (constant heating rate) conditions as follows, PSHRR/HtRt=HRC.

Thus, the mass loss rate of a sample heated to above its ignition temperature in an oxygen consumption calorimeter could be obtained simply by dividing the heat release rate HRR by the heat of combustion HOC at every point in time during the test. A non-contact mass loss rate measurement so described is only possible if there is no smearing or significant noise (uncertainty) in the oxygen consumption signal used to calculate the heat release rate in oxygen consumption calorimeters.

A number of thermoanalytical methods and commercial instruments (thermogravimetric analyzer or TGA) are available that use controlled thermal decomposition of milligram-sized samples to measure mass loss rate under well-defined (laboratory) conditions. In these instruments, the software programs allow for a user to set an essentially constant temperature during decomposition of the sample, while no software programs known to the inventors that are used with PCFC allow for a user to set such an essentially constant temperature during decomposition/pyrolysis. Simultaneous analysis of the evolved TGA gases permits calculation of the heat release and heat release rate using thermochemical calculations. Combustion of the evolved gases permits direct determination of the heat released by combustion, but heat release rate can only be measured if the oxygen consumed in burning the fuel gases is synchronized with their generation during the test. Of those known laboratory thermoanalytical methods that have been used to measure the heat of combustion of the sample gases under simulated fire conditions, all measure the total heat of combustion of the sample pyrolysis (fuel) gases. However, only the methods that measure or reproduce the mass loss rate of the sample can determine heat release rate of an individual material particle as it occurs at a burning surface in a fire. The heat release rate in a fire during steady flaming combustion is equal to the specific mass loss rate (rate at which the solid polymer decomposes into fuel which can enter the gas phase/flame) multiplied by the thickness of the heated surface layer (amount of solid polymer involved in the fuel generation process), the heat of combustion of the fuel gas (heat released per solid polymer by complete combustion), and the efficiency of the combustion process in the flame (fraction of solid polymer which enters the gas phase and is completely combusted). Because the rate of mass loss at the burning surface is a relatively slow process in comparison to the gas phase combustion reactions in the flame, the heat release in a fire is simultaneous with the mass loss (fuel generation) rate of the sample. Moreover, the temperature at which flaming combustion begins is essentially the temperature at which the sample mass loss (fuel generation) rate reaches a particular (critical) value. Consequently, unless the evolved gas measurement is synchronized with the sample mass loss in a laboratory test, the ignition temperature and heat release rate as they occur in a fire cannot be measured. One approach to obtain the rate of heat released by the sample under fire conditions is to measure mass loss (fuel gas generation) rate and heat of combustion of the fuel gases separately and then multiply them together.

In an aspect, the invention relates to a method of measuring the flammability parameters of a sample comprising:
(a) thermally decomposing the sample at an essentially constant temperature to generate fuel gases;
(b) transporting the fuel gases to a furnace via a carrier gas stream;
(c) combusting a mixture comprising the carrier gas and the fuel gases in the furnace; and
(d) analyzing the effluent generated in (c) to measure the flammability parameters of said sample;
   wherein if the fuel gases and the carrier gas together do not comprise a sufficient amount of oxygen adequate to allow for combustion before the combusting in (c), a sufficient amount of oxygen gas is added to the fuel gases and the carrier gas mixture prior to or during combusting in (c).

In one embodiment of this aspect, the invention encompasses a method of measuring the heat release rate of a sample comprising:
(a) thermally decomposing the sample at an essentially constant temperature in a pyrolysis chamber to generate fuel gases;
(b) transporting the fuel gases generated in (a) via a carrier gas stream to a furnace;
(c) combusting the fuel gases in the furnace generating a gaseous effluent, wherein the fuel gases comprise an amount of oxygen adequate to allow for combustion;
(d) measuring the amount of oxygen remaining in the gaseous effluent; and
(e) comparing the measured amount of oxygen remaining in the gaseous effluent with the amount of oxygen in the fuel gases prior to combustion in (c) to calculate the heat release rate of the sample.

In yet another embodiment of this aspect, the invention encompasses a method of measuring the heat release rate of a sample comprising:
(a) thermally decomposing the sample at an essentially constant temperature in a pyrolysis chamber to generate fuel gases;
(b) transporting the fuel gases in the order in which the fuel gases were produced in (a) via a carrier gas stream to a furnace;
(c) confining the fuel gases and the carrier gas stream from the pyrolysis chamber to the furnace within a tube of known volume;
(d) injecting a measured amount of oxygen into the fuel gases and carrier gas stream prior to combustion in the furnace;
(e) combusting the fuel gases in the furnace thereby generating a gaseous effluent;
(f) collecting the gaseous effluent from the furnace after combustion;
(g) removing unwanted substances from the effluent to produce a filtered effluent consisting essentially of said carrier gas stream and oxygen;
(h) measuring the oxygen content of the filtered effluent; and
(i) comparing the measured amount of oxygen injected prior to combustion with the oxygen content of the filtered effluent to calculate the heat release rate of the sample by applying a mathematical transform.

In certain embodiments of this aspect, the invention relates to a method for measuring the peak specific heat release rate of a polymeric compound, or composition comprising a polymeric compound and a flame retardant. The method can be used, for example, with PCFC, microscale combustion calorimeter, and flammability testers, as are known in the art (see, e.g., U.S. Pat. No. 5,981,290, U.S. Pat. No. 6,464,391, and US 2006/0133445) and can be used to determine the peak specific heat release rate of any type of polymeric compound that is amenable to combustion calorimetry analysis. Preferably, the method is combined with a combustion calorimeter that uses small sample sizes (e.g., on the order 1 to 10 milligram scale) to determine the combustion characteristics of polymeric materials, either pure or flame retardant containing polymers. A non-limiting example of a preferred type of combustion calorimeter is the pyrolysis combustion flow calorimeter (PCFC), also called “microscale combustion calorimeter” (MCC), which is described by Lyon, et al., in U.S. Pat. Nos. 5,981,290, 6,464,391, and published U.S. patent application 2006/0133445, each of which is incorporated herein by reference.

In some embodiments of the above aspect, the pyrolysis step (i.e., where the sample is thermally decomposed) is carried out under an inert atmosphere, for example under a nitrogen, argon, or helium atmosphere. In other embodiments, the thermal decomposition is performed in the presence of oxygen such as, for example, in an air environment, a mixed N₂/O₂ environment (e.g., 80/20, 75/25, 70/30, etc. N₂/O₂), or a pure O₂ environment, and the like. In some embodiments, such as (but not limited to) those embodiments wherein the sample is thermally decomposed under an inert atmosphere an amount of oxygen adequate to allow for combustion is added to the fuel gases prior to combustion of the fuel gases. The oxygen can be added by any common technique such as, for example, addition as a component of the carrier gas stream used to transport the fuel gases from the pyrolysis chamber to the furnace, by direct addition to the furnace, or by addition to the pyrolysis chamber after thermal decomposition, but before transporting of the fuel gases to the furnace. In some embodiments, an amount of oxygen is added to the fuel gases during combustion in the furnace. In some embodiments the invention is used with oxygen consumption calorimetry. In those embodiments that comprise oxygen consumption calorimetry, the amount of oxygen in the fuel gases prior to combustion is determined and compared to the amount of oxygen remaining in the gaseous effluent after combustion, as will be recognized by those of skill in the art.

The carrier gas stream used to transport the fuel gases from the pyrolysis chamber to the furnace can comprise any type of gas commonly used for transport in the field of thermal analysis, and that is well known in the art. Certain non-limiting examples of carrier gas stream include nitrogen, oxygen, air, mixtures of nitrogen and oxygen, helium, and argon.

In some embodiments the methods of the invention further comprise collecting the gaseous effluent from the furnace after the combustion of fuel gases and removing unwanted substances from the gaseous effluent to produce a filtered effluent. The oxygen content of the filtered effluent is analyzed and compared to the amount of oxygen present in the fuel gases prior to combustion. Methods for collecting and filtering gaseous effluent are well known to those of skill in the art.

In certain embodiments, the invention comprises a MCC or flammability tester comprising: (a) a length having a lower pyrolyzing region and an upper combustion region, wherein said pyrolyzing region thermally decomposes said sample under optionally anaerobic conditions to produce fuel gases; (b) a stream of gas within said length for transporting said fuel gases from said pyrolyzing region to said combustion region in substantial sequential flow; (c) means for inserting a measured amount of oxygen into said combustion region into said gas stream and said fuel gases, said measured amount of oxygen at least sufficient to completely combust said fuel gases within said combustion region; (d) means for collecting gases emerging from said combustion region; (e) means for measuring the amount of oxygen present in said gases emerging from said combustion region; and, (f) computational means for computing flammability parameters of said sample from said measured amount of oxygen inserted into said fuel gases and gas stream and the said amount of oxygen present in said gases emerging from said combustion region.

Such an apparatus can further comprise: (a) a sample holder in thermal contact with said sample; (b) a thermometer in thermal contact with said sample holder, and, (c) means for providing the temperature measured by said thermometer to said computational means for computing flammability parameters of said sample from said temperature, said measured amount of oxygen inserted into said fuel gases and gas stream, and said amount of oxygen present in said gases emerging from said combustion region. The length can have a number of different dimensions as well as configurations, such as having essentially a uniform cross section, essentially straight, and essentially vertical. Additional advantageous aspects to such an apparatus are described more completely in Published U.S. Patent Application 2006/0133445 (Lyon, et al.).

In an embodiment of this aspect, the method is used to measure thermodynamic properties of a sample comprising an organic polymer and a flame retardant agent. By maintaining a constant temperature for a fixed time period in the pyrolysis chamber during the thermal decomposition of the organic polymer and flame retardant agent, a value for the peak specific heat release rate (W/g) is obtained which has a better correlation to the peak heat release rate value (kW/m²) as determined by standard cone calorimetry. In some cases, this allows for a better estimate of the flammability of the polymer/retardant composition. It has been reported in the literature that the surface temperature of a flaming polymer is around 400-600° C. with heat fluxes in the range of 25-40 kW/m². In cone calorimtery, the surface temperature of the burning polymer has been measured around 300-900° C. depending on the heat fluxes and polymers. It was discovered by the inventors that operating PCFC in an isothermal condition similar to the surface temperature of a burning polymer may mimic better cone calorimetry even though PCFC is a significantly different testing apparatus from the cone calorimeter. The correlation between peak specific heat release rate from PCFC and peak heat release rate from cone calorimetry was surprisingly improved compared to the correlation established based on the conventional constant heating rate test method as described in the prior art.

In certain embodiments the temperature in the pyrolysis zone (pyrolysis chamber) is between 200° C. and 900° C. More preferably, the temperature in the pyrolysis zone is held essentially constant at a temperature that is within 250° C. of the decomposition temperature of the polymer or substance comprising the sample. For samples that comprise a plurality or mixture of polymer materials, the pyrolysis zone temperature can be maintained essentially constant at a temperature that is within 250° C. of the decomposition temperature of the polymer material that constitutes the highest weight percentage in the sample. Such decomposition temperature values can be found from various sources, such as in Flammability Handbook for Plastics, Carlos J. Hilado, 1982 (3^{rd} Ed.) Technomic Publishing, Westport, CT (ISBN 087762-306-6).

Generally, in the methods described herein, the sample is first pyrolyzed in an atmosphere which simulates sub-surface conditions in the pyrolysis zone of a burning material. This step is performed at an essentially constant temperature for a given amount of time, and leads to the thermal decomposition of the sample by quickly raising the temperature of the sample from room temperature to a selected temperature. The resulting volatile fuel gases are then mixed with known amount of oxygen before entering the combustion zone (typically a furnace). In the combustion zone, the temperature is typically set at 900° C. to induce complete combustion of volatiles. In particular for oxygen consumption calorimetry, the amount of oxygen that is added is known (or measureable) as the final measuring of the amount of oxygen remaining after combustion (residual oxygen in the effluent) allows for the calculation of heat release rate, effective heat of combustion, and other flammability parameters. Separately controlling the thermochemical reactions and thermophysical phenomena involved in the burning of organic materials in this way allows decoupling of the intrinsic chemical processes of material combustion from the transient effects associated with thermal diffusion in large samples.

The measuring of the residual amount of oxygen following combustion can be performed using any known method in the art, such as are incorporated in various software programs used in conjunction with fire calorimeters. The mathematical transforms that are used to calculate the final heat release rate of the sample are also well known in the art. Methods and systems for controlling thermal analysis equipment or calorimeter temperatures, such as the temperature in the pyrolysis zone/chamber and furnace are typically performed using computer executable software programs. Such programs are well known in the art, and are often packaged with calorimeter equipment and CPU hardware. For the methods of the invention comprising isothermal temperatures in the pyrolysis zone, one can author, reprogram, or further manipulate the known executable software programs such that the existing programs that do not allow for isothermal temperature control in the pyrolysis zone, will allow for such control.

### EXAMPLES

### Example 1

### Isothermal Peak Specific Heat Release Rate Determination

A series of flame retardant compounds are prepared in a Brabender mixer at 125-130° C. melt temperature for five minutes. Each material is then milled in a two roller machine for another five minutes at 110° C. The roll-milled material is then pressed into a 10 cm×10 cm plaque with a nominal thickness of 1.5 mm for cone calorimetry test. Table 1 lists the compositions comprising various flame retardant compounds and synergists in an ethylene ethyl acrylate (EEA) polymer matrix.

TABLE 1
Compositions containing flame retardants and synergists in EEA polymer matrix

| Component | Chemical Names | A1 | A2 | A3 | A4 | A5 |
|---|---|---|---|---|---|---|
| Amplify EA 103 | Ethylene ethyl acrylate | 49.30 | 44.30 | 49.30 | 44.30 | 49.30 |
| FR-20 S10 | Magnesium hydroxide | 50.00 | 45.00 | 45.00 | 45.00 | |
| Hubercarb G3 | Calcium Carbonate | | | | | 50.00 |
| Nanomax EVA | 50 wt % Nanoclay in EVA | | 10.00 | | | |
| Firebrake ZB | Zinc Borate | | | 5.00 | | |
| Fine | | | | | | |
| MB50-320 | 50% UHMW siloxane in EVA | | | | 10.00 | |
| Industrene 5016 | Stearic Acid | 0.50 | 0.50 | 0.50 | 0.50 | 0.50 |
| Irganox 1010 | Antioxidant | 0.20 | 0.20 | 0.20 | 0.20 | 0.20 |

| | | | | | |
|---|---|---|---|---|---|
| Total wt % | 100.00 | 100.00 | 100.00 | 100.00 | 100.00 |

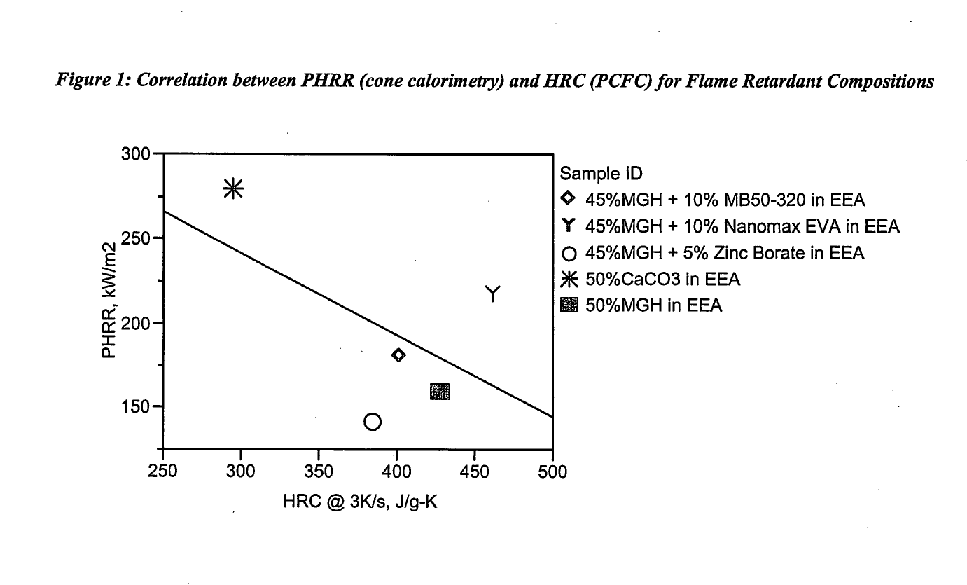

A standard cone calorimeter (Fire Testing Technology Limited, East Grinstead, UK) is used to measure heat release rate (kW/m²) as a function of time at 35 kW/m² irradiance according to the standard defined in ASTM E 1354. A metal grid is place on the top of the sample (10 cm×10 cm×1.5 mm) during the test. The heat release capacity (J/g-K) at a heating rate of 3 K/s is measured using a commercial PCFC (microscale combustion calorimeter, MCC) made by Govmark. To establish a value using known methods, the sample temperature in the pyrolysis zone is raised from the room temperature to 900° C., and the combustion zone is set at 900° C. FIG. 1 shows the correlation between heat release capacity using known heating method and peak heat release rate for compounds shown in Table 1. The correlation coefficient is 0.31 with negative slope. This is different from the positive slope reported in the literature for pure polymers (see, e.g., Lyon, R., et al., “Thermal Analysis of Flammability,” Flame Retardant 2006, pp. 111-122, 2006).

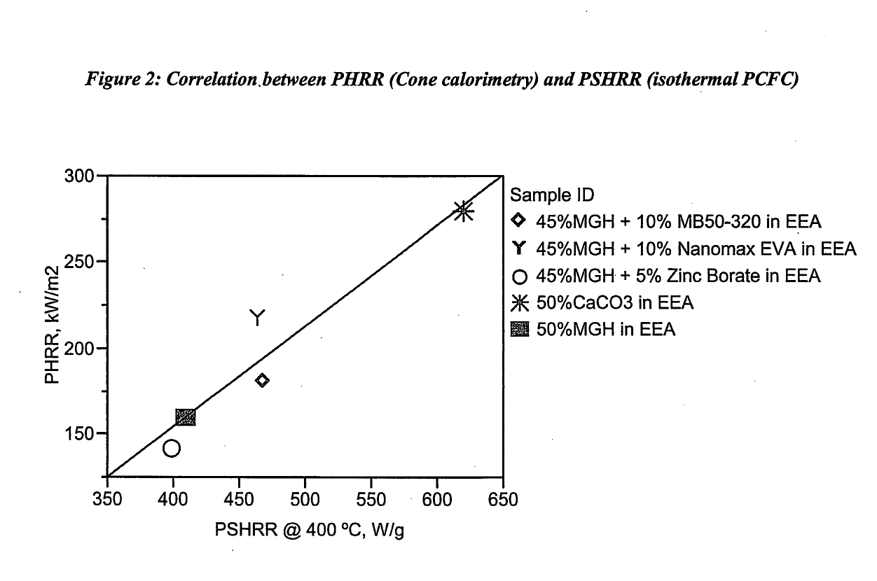

However, when the peak specific heat release rate (W/g) is measured by the “isothermal method” (that is, performing the decomposition at a constant temperature) at 400° C. using a PCFC, it has good correlation to peak heat release rate measured by cone calorimetry (see, FIG. 2). The correlation coefficient is 0.92.

TABLE 2
contains a series of flame retardant compounds in an ethylene-vinyl
acetate (EVA) polymer matrix.

| Component | Chemical Names | B1 | B2 | B3 | B4 | B5 |
|---|---|---|---|---|---|---|
| Elvax 265 | Ethylene vinyl acetate, 28% VA, 3 | 49.30 | 44.30 | 49.30 | 44.30 | 49.30 |
| | MI | | | | | |
| FR-20 S10 | magnesium hydroxide | 50.00 | 45.00 | 45.00 | 45.00 | |
| Hubercarb G3 | Calcium Carbonate | | | | | 50.00 |
| Nanomax EVA | Nanoclay | | 10.00 | | | |
| Firebrake ZB Fine | Zinc Borate | | | 5.00 | | |
| MB 50 320 | Ultra high MW Silicone Masterbatch | | | | 10.00 | |
| Industrene 5016 | Stearic Acid | 0.50 | 0.50 | 0.50 | 0.50 | 0.50 |
| Irganox 1010 | Antioxidant | 0.20 | 0.20 | 0.20 | 0.20 | 0.20 |
| | Total wt % | 100.00 | 100.00 | 100.00 | 100.00 | 100.00 |

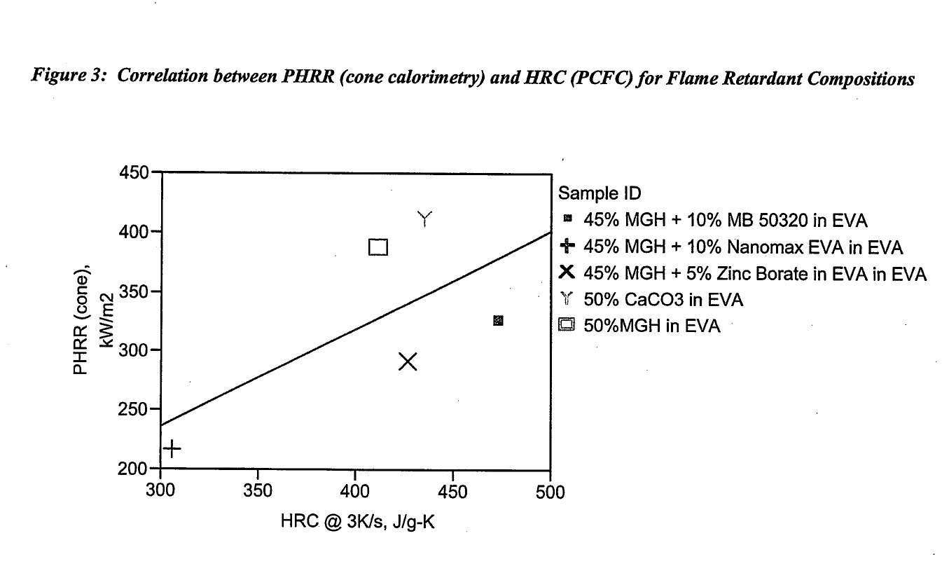

FIG. 3 shows the correlation between heat release capacity measured using a known heating method at 3K/s heating rate in microscale combustion calorimeter and peak heat release rate measured by cone calorimeter for compounds shown in Table 2. The correlation coefficient is 0.44.

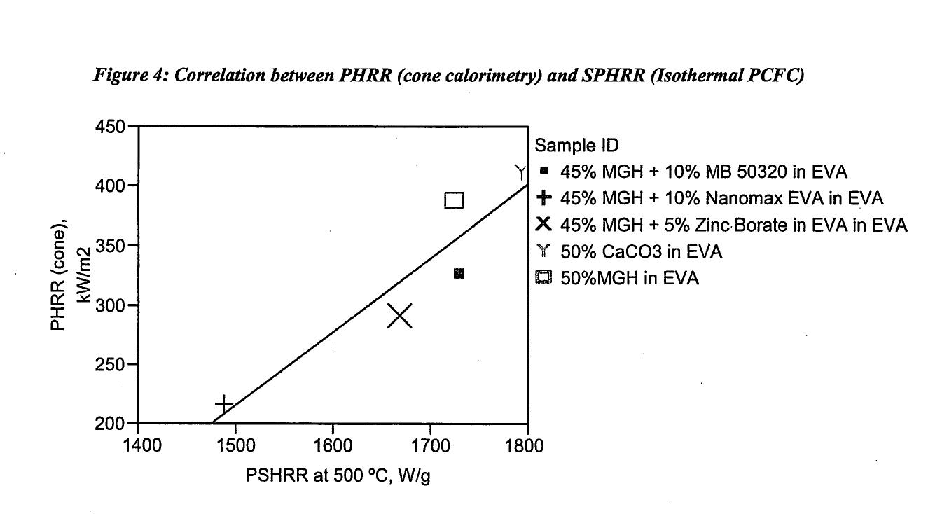

When the peak specific heat release rate is measured by the isothermal method at 500° C. using the PCFC, it has a much improved correlation with the peak heat release rate as measured by cone calorimetry (see, FIG. 4). The correlation coefficient is calculated to be 0.86.

In the isothermal PCFC, the sample is pressed into a thin film with about 150 micron thickness and about 3 mg of the sample is cut from the pressed film for testing. The nitrogen and oxygen flow rates are set at 80 ml/min and 20 ml/min, respectively. The temperature of the sample is then raised to the target temperature at a rate of 3 to 10° C./sec and is held at the target temperature for 10 minutes. The combustion zone (furnace) is typically set at 900° C. The oxygen concentration is monitored during the test and is used to calculate the peak specific heat release rate of the sample based on oxygen consumption rate.

While the invention has been described above in terms of general aspects, certain embodiments and specific examples, the foregoing disclosure should not be taken as limiting the scope of the invention, which is defined by the appended claims.

We claim:

1. A method of measuring the flammability parameters of a sample comprising:
(a) thermally decomposing the sample at an essentially constant temperature to generate fuel gases;
(b) transporting the fuel gases to a furnace via a carrier gas stream;
(c) combusting a mixture comprising the carrier gas and the fuel gases in the furnace; and
(d) analyzing the effluent generated in (c) to measure the flammability parameters of said sample;
wherein if the fuel gases and the carrier gas together do not comprise a sufficient amount of oxygen gas adequate to allow for combustion before the combusting in (c), a sufficient amount of oxygen gas is added to the fuel gases and the carrier gas mixture prior to or during combusting in (c).

2. The method of claim 1, wherein the sample comprises a polymer.

3. The method of any of claims 1 or 2, wherein the sample comprises a flame retardant agent.

4. The method of claim 3, wherein the essentially constant temperature is from about 100° C. to about 900° C.

5. The method of claim 3, wherein the essentially constant temperature is about 400° C. to about 600° C.

6. The method of claim 3, wherein the thermal decomposition step (a) is performed under an atmosphere consisting essentially of nitrogen.

7. A method for providing a quantitative measure of combustion dynamics of a sample comprising:
(a) thermally decomposing the sample at an essentially constant temperature in a pyrolysis chamber to generate fuel gases;
(b) transporting the fuel gases generated in (a) via a carrier gas stream to a furnace;
(c) combusting the fuel gases in the furnace generating a gaseous effluent, wherein the fuel gases comprise an amount of oxygen adequate to allow for combustion;
(d) measuring the amount of oxygen remaining in the gaseous effluent; and
(e) comparing the measured amount of oxygen remaining in the gaseous effluent with the amount of oxygen in the fuel gases prior to combustion in (c) to calculate the heat release rate of the sample.

8. The method of claim 7, wherein the sample comprises a polymer.

9. The method of claim 8, wherein the sample further comprises a flame retardant agent.

10. The method of claim 9, wherein the essentially constant temperature is from about 100° C. to about 900° C.

11. The method of claim 9, wherein the essentially constant temperature is from about 400° C. to about 600° C.

12. The method of claim 9, wherein the thermal decomposition step (a) is performed under an atmosphere consisting essentially of nitrogen, and wherein the transporting step (b) is performed using a nitrogen carrier gas stream.

13. A method of measuring the heat release rate of a sample comprising:
(a) thermally decomposing the sample at an essentially constant temperature in a pyrolysis chamber to generate fuel gases;
(b) transporting the fuel gases generated in (a) via a carrier gas stream to a furnace;
(c) combusting the fuel gases in the furnace generating a gaseous effluent, wherein the fuel gases comprise an amount of oxygen adequate to allow for combustion;
(d) measuring the amount of oxygen remaining in the gaseous effluent; and
(e) comparing the measured amount of oxygen remaining in the gaseous effluent with the amount of oxygen in the fuel gases prior to combustion in (c) to calculate the heat release rate of the sample.

14. The method of claim 13, wherein the sample comprises a polymer.

15. The method of claim 14, wherein the sample further comprises a flame retardant agent.

16. The method of claim 15, wherein the constant temperature is from about 100C to about 900° C.

17. The method of claim 15, wherein the essentially constant temperature is from about 400° C. to about 600° C.

18. The method of claim 15, wherein the thermal decomposition step (a) is performed under inert conditions, and wherein the transporting step (b) is performed using an inert carrier gas stream.

19. The method of any of claims 3, 9, or 15, wherein the essentially constant temperature is within 250° C. above or below the decomposition temperature of the polymer material that comprises the highest weight percentage in the sample.
